(19) United States
(12) Patent Application Publication
(10) Pub. No.: US 2011/0129804 A1
(43) Pub. Date: Jun. 2, 2011

(54) EDUCATIONAL ROBOT APPARATUS FOR CHILDREN AND METHOD OF OPERATING THE SAME

(75) Inventors: Young-Suk Choi, Seoul (KR); Min-Young Lee, Seoul (KR)

(73) Assignee: ROBOROBO CO., LTD., Seoul (KR)

(21) Appl. No.: 12/741,903

(22) PCT Filed: Aug. 12, 2009
(86) PCT No.: PCT/KR2009/004502

§ 371 Date: May 7, 2010

(30) Foreign Application Priority Data
Nov. 13, 2008 (KR) 1020080112597

(51) Int. Cl. G09B 19/00

(52) U.S. Cl. 434/118; 901/2

(57) ABSTRACT

An educational robot apparatus for children, as a type of a user created robot (UCR), includes a robot and a robot control program having a decoder, a controller and a transferor. The decoder scans an input card and has first and second photo-interrupter. The input card includes an information code and a reference code. The information code has a code information written as a barcode shape. The code information corresponds to an imperative sentence included in a robot control program. The reference code is written as a uniform barcode shape and is used in decoding the code information. The first photo-interrupter reads the information code and decodes the code information, and the second photo-interrupter decodes the reference code. The controller codes the robot control program based on the code information decoded by the decoder. The transferor transfers the robot control program to the robot.

### TECHNICAL FIELD

The present invention relates to an educational robot apparatus for children and a method of operating the educational robot apparatus, and more particularly to an educational robot apparatus for children capable of being easily controlled and a method of operating the educational robot apparatus.

### BACKGROUND ART

A robot may be classified into an industrial robot for manufacturing products in an industrial field and an educational robot for educating users about operating principles of the robot. Recently, as technology is developed, the robot may be operated with a remote controller based on a control program coded by the users using computers. Thus, the control program should be prepared to control the robot using the computer, and then the control program is transferred to a main processing unit of the robot to operate the robot.

However, as the robot is controlled or operated based on the control program coded by the computers, children having little knowledge about the computer may have difficulty in controlling the computer-based robot, and the computer-based robot may not be operated in a condition without the computer.

### DISCLOSURE

### Technical Problem

The present invention provides an educational robot apparatus for children capable of being easily controlled and operated by a user who has less ability to use a computer.

The present invention also provides a method of operating the educational robot apparatus for children.

### Technical Solution

According to an example embodiment of the present invention, an educational robot apparatus for children includes a robot and a robot control program input device. The robot control program input device includes a decoder, a controller and a transferor. The decoder scans an input card and has first and second photo-interrupter. The input card includes an information code and a reference code. The information code has a code information written as a barcode shape, and the code information corresponds to an imperative sentence included in a robot control program. The reference code is written as a uniform barcode shape and is used in decoding the code information. The first photo-interrupter reads the information code and decodes the code information, and the second photo-interrupter decodes the reference code. The controller codes the robot control program based on the code information decoded by the decoder. The transferor transfers the robot control program to the robot.

In an example embodiment, the reference code compensates the code information so that the code information is normally decoded from the information code. The educational robot apparatus for children further includes a storage storing an imperative sentence corresponding to the code information decoded by the decoder.

In an example embodiment, the robot control program is coded using at least one input card continuously. The robot control program input device further includes a display part displaying whether the code information corresponding to the input card is normally decoded by the first photo-interrupter. The display part displays a number of the input card normally decoded and a number of the input card abnormally decoded, so that a user confirms whether the code information is normally decoded.

In an example embodiment, the robot includes a switch operating a series of movements of the robot based on the robot control program coded by a series of the code information when the series of the code information respectively corresponding to the series of input cards are normally decoded.

In an example embodiment, the movements of the robot include going straight/backward, turning left/right, stopping and so on.

According to another example embodiment of the present invention, a method of operating an educational robot apparatus for children includes decoding a code information from an input card including an information code and a reference code. The code information corresponds to an imperative sentence included in a robot control program. The information code has a code information written as a barcode shape. The reference code is written as a uniform barcode shape and is used in decoding the code information. The robot control program is coded based on the decoded code information. The robot control program is transferred to a robot. The robot is operated based on the robot control program.

In an example embodiment, the method further includes compensating the code information so that the code information is normally decoded from the information code.

In an example embodiment, the method further includes storing the imperative sentence corresponding to the decoded code information, and further includes reading the imperative sentence corresponding to the stored code information. The code information corresponds to a collection of the imperative sentence including at least one imperative sentence operating at least one specific movement of the robot, and at least one imperative sentence is written in at least one input card as the information code. The imperative sentence is stored corresponding to the decoded code information by sequentially storing at least one imperative sentence of the collection of the imperative sentence. Each of the input cards is used at least one time.

### Advantageous Effects

According to the present invention, a user who is not familiar to the computer like children may easily input a robot control program to a robot, and may input the robot control program to the robot without the computer.

In addition, a plurality of codes having a bar-code type may be used to transfer a correct robot control program to the robot, and a plurality of input cards may be combined to input various kinds of orders.

### DESCRIPTION OF DRAWINGS

FIG. 1 is a perspective view illustrating an educational robot apparatus for children according to an example embodiment of the present invention.

FIG. 2 is a perspective view illustrating an educational robot apparatus for children according to another example embodiment of the present invention.

FIG. 3 is a block diagram illustrating a robot control program input device in FIGS. 1 and 2.

FIG. 4 is a plan view illustrating an input card in FIGS. 1 and 2.

FIGS. 5 and 6 are flowcharts illustrating a method of operating the educational robot apparatus according to still another example embodiment of the present invention.

### BEST MODE

Embodiments of the present invention now will be described more fully with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, the present invention will be described in detail with reference to the accompanying drawings.

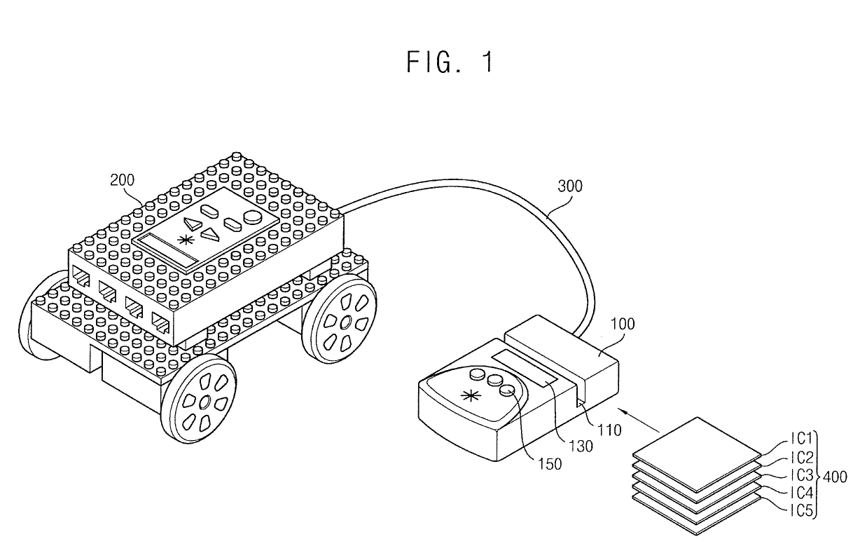

FIG. 1 is a perspective view illustrating an educational robot apparatus for children according to an example embodiment of the present invention.

Referring to FIG. 1, the educational robot apparatus according to the present example embodiment includes a robot control program input device 100, a robot 200, an interface 300 and an input card 400.

A robot control program corresponding to a specific movement is transferred to the robot 200 from the robot control program input device 100 through the interface 300. The robot 200 performs the specific movement.

The robot control program input device 100 includes a sliding groove 110, a display part 130 and a switch 150.

The robot control program input device 100 scans the input card 400 having a code information using the sliding groove 110. In this case, both ends of the sliding groove 110 are opened. When the input card 400 sequentially slides both ends of the sliding groove 110, the input card 400 is scanned and then the code information is written in the robot control program input device 100.

The input card 400 may include a first input card IC1, a second input card IC2, a third input card IC3, a fourth input card IC4 and a fifth input card IC5. Each of the first to fifth input cards IC1 to IC5 may have an information code corresponding to an imperative sentence to perform the specific movement of the robot 200.

For example, the imperative sentence corresponding to the first input card IC1 forces the robot to go straight. The imperative sentence corresponding to the second input card IC2 forces the robot to turn left. The imperative sentence corresponding to the third input card IC3 forces the robot to turn right. The imperative sentence corresponding to the fourth input card IC4 forces the robot to go backward. The imperative sentence corresponding to the fifth input card IC5 forces the robot to stop.

The first to fifth input cards IC1 to IC5 may be sequentially scanned by the sliding groove 110. Alternatively, the first to fifth input cards IC1 to IC5 may be scanned with various kinds of orders by the sliding groove 110 to perform the specific movement. Thus, the robot 200 may operate with various kinds of movements based on the combination of the input cards. In this case, each of the first to fifth input cards IC1 to IC5 has an eigennumber.

The display part 130 displays whether the robot control program input device 100 decodes the information code of the input card 400 normally or abnormally. For example, the display part 130 displays a number of the input card normally decoded and a number of the input card abnormally decoded.

For example, when the first input card IC1 is scanned and the robot control program input device 100 normally decodes the information code of the input card 400, the display part 130 displays that the first input card IC1 is normal. However, when the robot control program input device 100 abnormally decodes the information code of the input card 400, the display part 130 displays that the first input card IC1 is abnormal.

Accordingly, a user may recognize whether the first input card IC1 is normally or abnormally decoded. Thus, when the first input card IC1 is normally decoded, the second input card IC2 may be scanned to perform the next movement. When the first input card IC1 is abnormally decoded, the first input card IC1 should be scanned again.

When the first to fifth input cards IC1 to IC5 are normally decoded, the robot operates with the specific movements based on the imperative sentences corresponding to the first to fifth input cards IC1 to IC5. In this case, the switch 150 may control a start of the specific movements. For example, when the specific movements are completed based on the combination of the input cards, the switch 150 may start the specific movements of the robot.

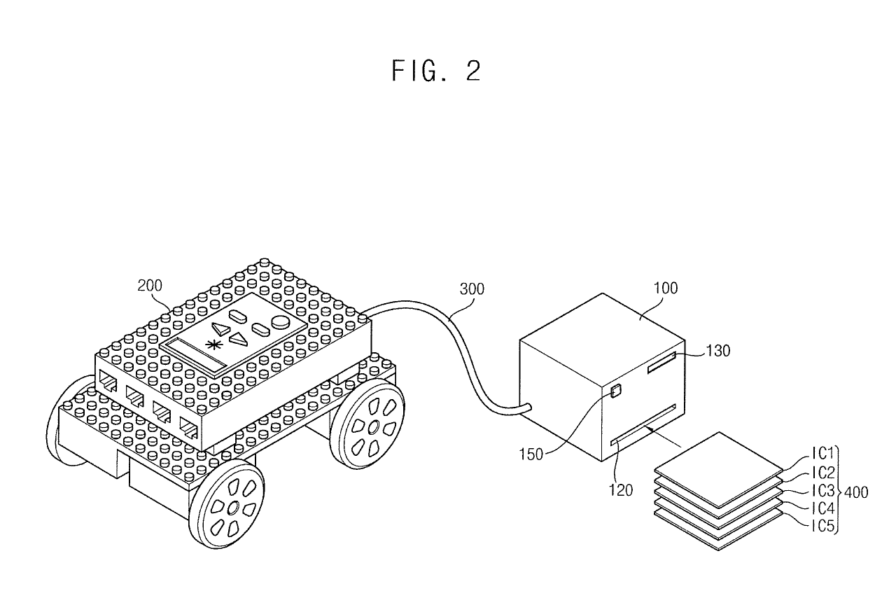

FIG. 2 is a perspective view illustrating an educational robot apparatus for children according to another example embodiment of the present invention.

The robot control program input device 100 according to the present example embodiment is substantially same as the robot control program input device according to the previous example embodiment except that the robot control program input device 100 includes an insertion 120. Thus, the same reference numerals are used and further repetitive explanation will be omitted.

The input card 400 having the code information is inserted to the robot control program input device 100 through the insertion 120. For example, the input card 400 is inserted to the insertion 120 and is scanned by the robot control program input device 100, so that the code information may be written in the robot control program input device 100. The input card 400 is scanned by a decoder 160, and then is extracted from the insertion 120 automatically or by pushing an extraction button (not shown).

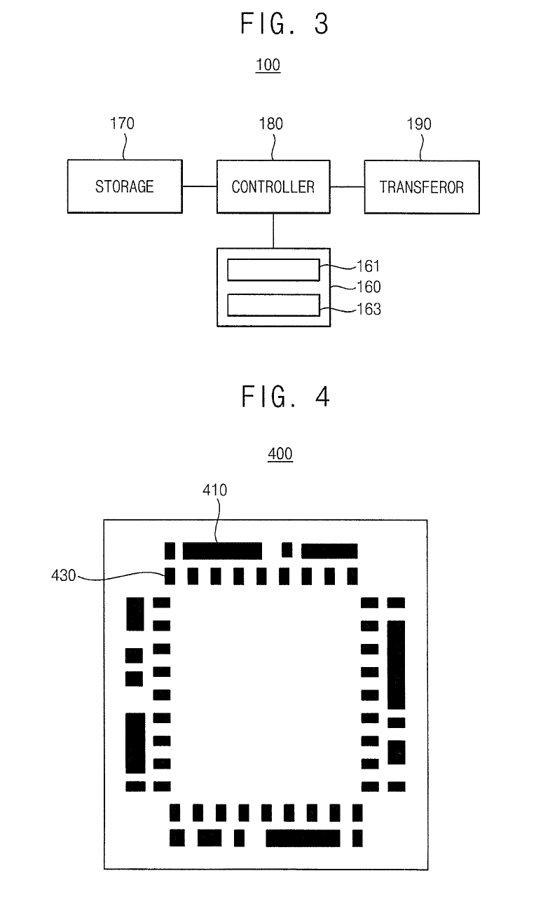

FIG. 3 is a block diagram illustrating a robot control program input device in FIGS. 1 and 2. FIG. 4 is a plan view illustrating an input card in FIGS. 1 and 2.

Referring to FIGS. 1 to 4, the robot control program input device 100 includes a decoder 160, a storage 170, a controller 180 and a transferor 190.

The decoder 160 decodes the code information of the imperative sentence included in the robot control program from the input card 400.

The decoder 160 includes a first photo-interrupter 161 and a second photo-interrupter 163.

The input card 400 includes an information code 410 and a reference code 430. In the present example embodiment, the information code 410 is formed outside of the reference code 430. Alternatively, the reference code 430 may be formed outside of the information code 410.

The information code 410 has a barcode shape, and includes the code information of the imperative sentence included in the robot control program. The code information is decoded using the first photo-interrupter 161, and is compensated using the second photo-interrupter 163. The first and second photo-interrupters 161 and 163 recognize black-colored and white-colored marks using the amount of infrared light reflected after being irradiated to the input card 400. For example, the black-colored mark absorbs the infrared light more than the white-colored mark and reflects less than the white-colored mark, so that the black-colored and white-colored marks may be recognized.

The code information stored in the information code 410 is decoded through the first photo-interrupter 161, when the input card 400 passes through the decoder 160 of the robot control program input device.

The second photo-interrupter 163 recognizes a barcode mark of the reference code 430 and compensates the first photo-interrupter 161, so that the first photo-interrupter 161 may correctly decode the code information.

For example, when the input card 400 passes through the first and second photo-interrupters 161 and 163, the barcode mark written in the information code 410 is compared to the barcode mark written in the reference code 430, and then the code information is correctly decoded.

For example, when the information code 410 included in the first input card IC1 which may correspond to the imperative sentence forcing the robot to go straight passes through the first photo-interrupter 161, the robot control program input device 100 operates the robot 200 to go straight.

In this case, the code information may include a collection of a plurality of imperative sentences. For example, the plurality of imperative sentences may be required to operate the robot 200 with the specific movement. The imperative sentences may form a single collection, and the single collection of the imperative sentences corresponds to the code information, so that the robot 200 may be operated with the specific movement.

The collection of the imperative sentences may include the imperative sentences on a driving of a direct current (DC) motor to determine a velocity of the robot 200 and to operate the robot 200 going straight/backward, turning left/right, stopping, etc., the imperative sentences on a driving of a servo motor to operate the robot 200 within a predetermined angle, the imperative sentences to perform the specific movement of the robot 200 repeatedly, the imperative sentences to perform the specific movement of the robot 200 in response to the infrared light, a pressure, etc, the imperative sentences to perform the specific movement of the robot 200 by a predetermined interval, and so on.

For example, the code information corresponding to the collection of the imperative sentences controlling the specific operation of the robot 200 may be used to force the robot 200 to go straight via driving the DC motor for the predetermined interval. In this case, the collection includes the imperative sentence forcing the robot to go straight corresponding to the first input card IC1, and the imperative sentence controlling the operating time and the velocity of the robot corresponding to an input card. Accordingly, the robot control program input device 100 may reorganize the code information to operate the robot 200 going straight with the predetermined time and velocity.

The user inputs the robot control program to the robot 200 using the input card 400 having a series of code information corresponding to the collection of the imperative sentences. For example, the user may arrange the input cards 400 having the information code 410 corresponding to the collection of the imperative sentences, and the arranged input cards 400 may pass through the decoder 160 of the robot control program input device 100, so that the robot control program including the collection of the imperative sentences may be coded.

The reference code 430 has a barcode shape which is uniformly arranged.

The reference code 430 may prevent the input card 400 from being unread due to an irregular speed of the input card 400 passing though the first and second photo-interrupters 161 and 163, defects of the barcode of the input card 400, and so on.

In addition, the reference code 430 may compensate the code information to correctly decode the code information stored in the information code 410, when the first photo-interrupter 161 decodes the code information.

The input card 400 in FIG. 3 has a rectangular shape. Alternatively, since the information code 410 and the reference code 430 are written in a portion spaced apart from sides of the input card 400 by a predetermined distance, the input card 400 may have a polygonal shape having more sides to store more information.

In addition, the input card 400 may include the reference code 430 and the information code 410 written in front and rear surfaces of the input card 400.

The code information is packed and written in the information code 410. Thus, the robot control program may be inputted to the robot with one input card 400 when using the information code 410 which is packed and stored.

The storage 170 stores the imperative sentence corresponding to the code information decoded by the decoder 160. In this case, the storage 170 may store the collection of the imperative sentences corresponding to the code information.

For example, when the decoder 160 decodes the code information operating the robot to go straight, the controller 180 codes the robot control program using the imperative sentence which forces the robot to go straight and is stored in the storage 170.

The storage 170 stores the imperative sentence corresponding to the code information, but the storage 170 may be omitted when the imperative sentence is directly written in the information code 410.

The controller 180 reads the imperative sentence stored in the storage 170 using the code information decoded by the decoder 160. Then, the robot control program is coded using the imperative sentence.

Thus, when the code information decoded by the decoder 160 is plural, the controller 180 arranges the imperative sentences corresponding to the plurality of code information to code the robot control program. In addition, the collection of the imperative sentences respectively corresponding to the plurality of code information is arranged to code the robot control program.

When the storage 170 is omitted, the controller 180 may code the robot control program using the imperative sentences written in the information code 410.

The transferor 190 transfers the robot control program coded by the controller 180 to the robot 200.

The transferor 190 of the robot control program input device may be connected by the interface 300. The interface 300 is connected to a main processing unit of the robot 200, and transfers the robot control program coded by the controller 180.

In the present example embodiment, the interface 300 is connected with a wire. Alternatively, the interface 300 may be wirelessly connected, and the wireless interface 300 may include a wireless connecting system.

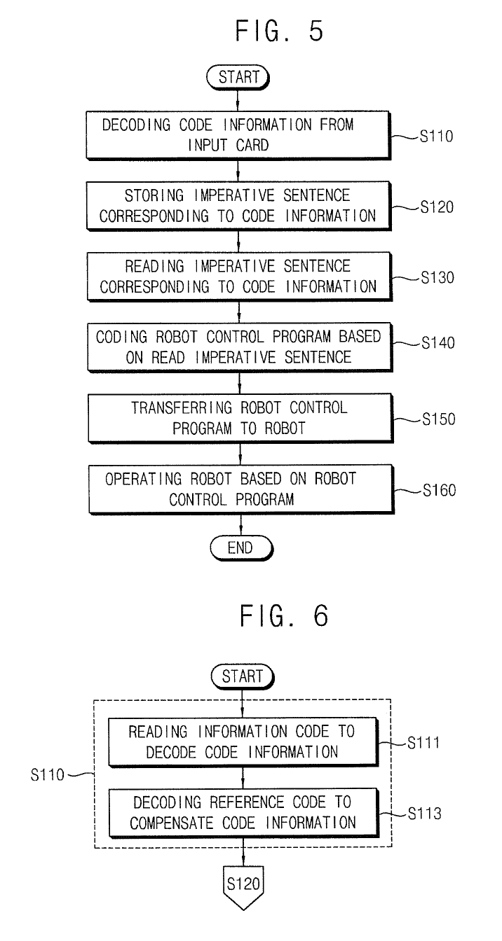

FIGS. 5 and 6 are flowcharts illustrating a method of operating the educational robot apparatus according to still another example embodiment of the present invention.

Referring to FIGS. 1, 2, 5 and 6, when the input card 400 is scanned by the decoder 160 through the sliding groove 110 and the insertion 120, the decoder 160 of the robot control program input device decodes the code information on the imperative sentences included in the robot control program from the input card 400 (step S110).

In this case, the code information is stored in the information code 410 of the input card 400. The code information stored in the information code 410 is decoded by the first photo-interrupter 161 of the decoder 160 (step S111). For example, when the input card 400 passes through the decoder 160, the photo-interrupter 161 reads the information code 410 to decode the code information.

At this time, the second photo-interrupter 163 decodes the reference code 430 to compensate the code information (step S113).

Then, the imperative sentence corresponding to the code information is stored in the storage 170 (step S120). The collection having the plurality of imperative sentences may be stored in the storage 170 to perform the specific movement of the robot. For example, the plurality of imperative sentences is sequentially stored in the storage 170.

Then, the controller 180 reads the imperative sentence or the collection of the imperative sentences from the storage 170 (step S130).

The robot control program is coded from the read imperative sentence (step S140). In addition, the robot control program may be coded from the collection having the plurality of imperative sentences sequentially stored.

Then, the robot control program coded by the series of the imperative sentences is transferred from the transferor 190 to the robot 200 through the interface 300 (step S150).

Then, the robot 200 finally receives the robot control program and performs the specific movement corresponding to the robot control program (step S160).

Accordingly, when the robot control program input device 100 scans the input card 400 with changing the arrangement or the kinds of the imperative sentences, the robot 200 performs the specific movement corresponding to the arrangement or the kinds of the imperative sentences. Thus, the user may easily control the robot 200.

Having described the example embodiments of the present invention and its advantages, it is noted that various changes, substitutions and alterations can be made herein without departing from the spirit and scope of the invention as defined by appended claims.

### INDUSTRIAL APPLICABILITY

The apparatus and the method according to the present invention may have industrial applicability applied to industry of an educational robot for children as a type of a user created robot (UCR).

1. An educational robot apparatus for children comprising:
a robot; and
a robot control program input device comprising:
a decoder scanning an input card and having first and second photo-interrupter, the input card including an information code and a reference code, the information code having a code information written as a barcode shape, the code information corresponding to an imperative sentence included in a robot control program, the reference code being written as a uniform barcode shape and being used in decoding the code information, the first photo-interrupter reading the information code and decoding the code information, the second photo-interrupter decoding the reference code,
a controller coding the robot control program based on the code information decoded by the decoder, and
a transferor transferring the robot control program to the robot.

2. The educational robot apparatus of claim 1, wherein the reference code compensates the code information so that the code information is normally decoded from the information code.

3. The educational robot apparatus of claim 1, further comprising a storage storing an imperative sentence corresponding to the code information decoded by the decoder.

4. The educational robot apparatus of claim 1, wherein the robot control program is coded using at least one input card continuously.

5. The educational robot apparatus of claim 4, wherein the robot control program input device further comprises a display part displaying whether the code information corresponding to the input card is normally decoded by the first photo-interrupter.

6. The educational robot apparatus of claim 5, wherein the display part displays a number of the input card normally decoded and a number of the input card abnormally decoded, so that a user confirms whether the code information is normally decoded.

7. The educational robot apparatus of claim 6, wherein the robot comprises a switch operating a series of movements of the robot based on the robot control program coded by a series of the code information when the series of the code information respectively corresponding to the series of input cards are normally decoded.

8. The educational robot apparatus of claim 7, wherein the movements of the robot comprise going straight/backward, turning left/right, stopping and so on.

9. A method of operating an educational robot apparatus for children, the method comprising:
decoding a code information from an input card including an information code and a reference code, the code information corresponding to an imperative sentence included in a robot control program, the information code having a code information written as a barcode shape, the reference code being written as a uniform barcode shape and being used in decoding the code information;
coding the robot control program based on the decoded code information;
transferring the robot control program to a robot; and
operating the robot based on the robot control program.

10. The method of claim 9, further comprising compensating the code information so that the code information is normally decoded from the information code.

11. The method of claim 10, further comprising storing the imperative sentence corresponding to the decoded code information.

12. The method of claim 11, further comprising reading the imperative sentence corresponding to the stored code information.

13. The method of claim 12, wherein the code information corresponds to a collection of the imperative sentence including at least one imperative sentence operating at least one specific movement of the robot, and at least one imperative sentence is written in at least one input card as the information code.

14. The method of claim 13, wherein storing the imperative sentence corresponding to the decoded code information comprises:
sequentially storing at least one imperative sentence of the collection of the imperative sentence.

15. The method of claim 13, wherein each of the input cards is used at least one time.
